(19) United States
(12) Patent Application Publication
(10) Pub. No.: US 2015/0331043 A1
(43) Pub. Date: Nov. 19, 2015

(54) SYSTEM-ON-CHIP SECURE DEBUG

(71) Applicants: Manoj R. Sastry, Portland, OR (US); Enrico D. Carrieri, Rancho Cordova, CA (US); Michael Neve de Mevergnies, Beaverton, OR (US); Ioannis T. Schoinas, Portland, OR (US); Michael J. Wiznerowicz, Tigard, OR (US)

(72) Inventors: Manoj R. Sastry, Portland, OR (US); Enrico D. Carrieri, Rancho Cordova, CA (US); Michael Neve de Mevergnies, Beaverton, OR (US); Ioannis T. Schoinas, Portland, OR (US); Michael J. Wiznerowicz, Tigard, OR (US)

(21) Appl. No.: 14/279,007

(22) Filed: May 15, 2014

(51) Int. Cl. G01R 31/3177; G06F 21/76

(52) U.S. Cl. CPC G01R 31/3177; G06F 21/76

(57) ABSTRACT

A system on chip (SOC) includes a policy generator to identify lifecycle data that identifies a lifecycle of the SOC and identify authentication data that identifies a particular user that is to debug the SoC. A particular policy is determined based on the lifecycle and identification of the particular user, and policy data is sent to at least one block of the SoC, the policy data identifying the particular policy. Debug access at the block is based on the particular policy.

### FIELD

This disclosure pertains to computing system, and in particular (but not exclusively) to system-on-chip architectures.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors.

Processor chips have evolved significantly in recent decades. The advent of multi-core chips has enabled parallel computing and other functionality within computing devices including personal computers and servers. Processors were originally developed with only one core. Each core can be an independent central processing unit (CPU) capable of reading executing program instructions. Dual-, quad-, and even hexa-core processors have been developed for personal computing devices, while high performance server chips have been developed with upwards of ten, twenty, and more cores. Cores can be interconnected along with other on-chip components utilizing an on-chip interconnect of wire conductors or other transmission media. Such chips can be implemented as system-on-chip (SoC) devices. Scaling the number of cores on a chip can challenge chip designers seeking to facilitate high-speed interconnection of the cores. Further, such devices and their related firmware and software can be subject to testing and debugging so as to ensure proper operation.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates embodiments of potential high performance interconnect (HPI) system configurations.

FIG. 6 illustrates an embodiment of a system on chip (SoC) including a policy generator block.

FIG. 7 illustrates operation of an example policy generator block of a SoC.

FIG. 8 illustrates details of an embodiment of a policy generator block of a SoC.

FIG. 9 illustrates details of an embodiment of policy enforcer logic of an example computing block of an SoC.

FIGS. 10A-10B are flowcharts illustrating example techniques associated with managing debug policies for a SoC.

FIG. 11 illustrates an embodiment of a block diagram for a computing system including a multicore processor.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the subject matter of the present Specification. It will be apparent, however, to one skilled in the art that these specific details need not be employed to practice the methods, apparatus, articles, and systems, etc. described in the present Specification. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the discussion of the subject matter of the present Specification.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate to software optimizations for energy conservation and efficiency. As will become readily apparent in the description below, the embodiments of methods, apparatus′, and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. While some specific examples of interconnect architectures are named and discussed below, it should be appreciated that the principles described in this Specification can potentially be applied to a number of other, unnamed, and yet to be formalized interconnect architectures, which would potentially also benefit from aspects of the subject matter described herein.

Examples of interconnect fabric architectures include the Peripheral Component Interconnect (PCI), Peripheral Component Interconnect (PCI) Express (PCIe), Quick Path Interconnect (QPI), High Performance Interconnect (HPI) (e.g., a serial point-to-point differential protocol with embedded clock), and Advanced Microcontroller Bus Architecture (AMBA) AXI architectures, among other examples. A primary goal of at least some interconnect architectures, such as load-store I/O architectures such as PCIe, is to enable components and devices from different vendors to inter-operate in an open architecture, spanning multiple market segments; Clients (Desktops and Mobile), Servers (Standard and Enterprise), and Embedded and Communication devices. As an example, PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

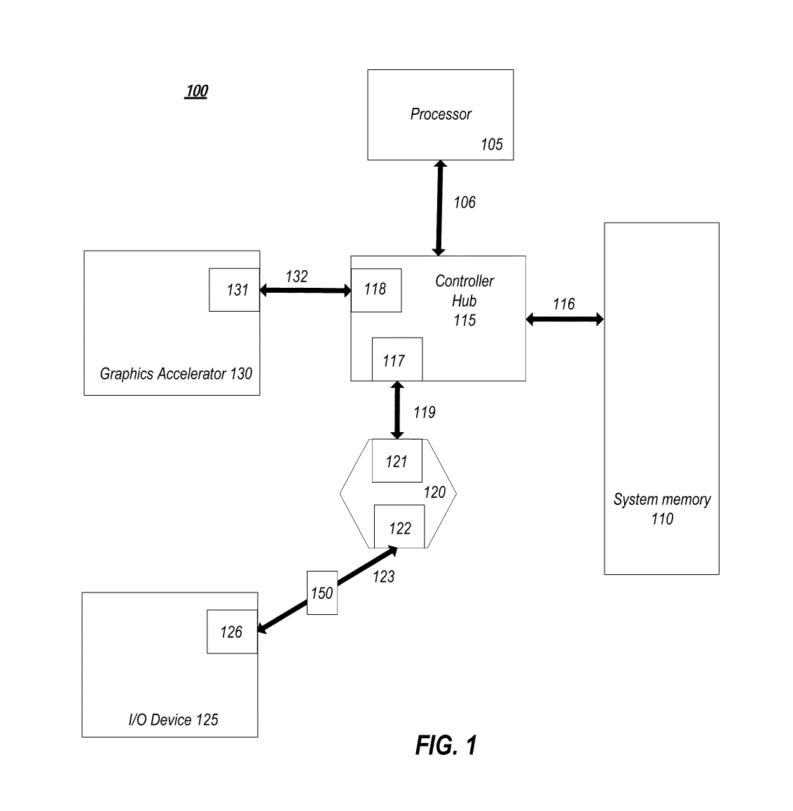

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in an interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual bridge devices, such as PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105.

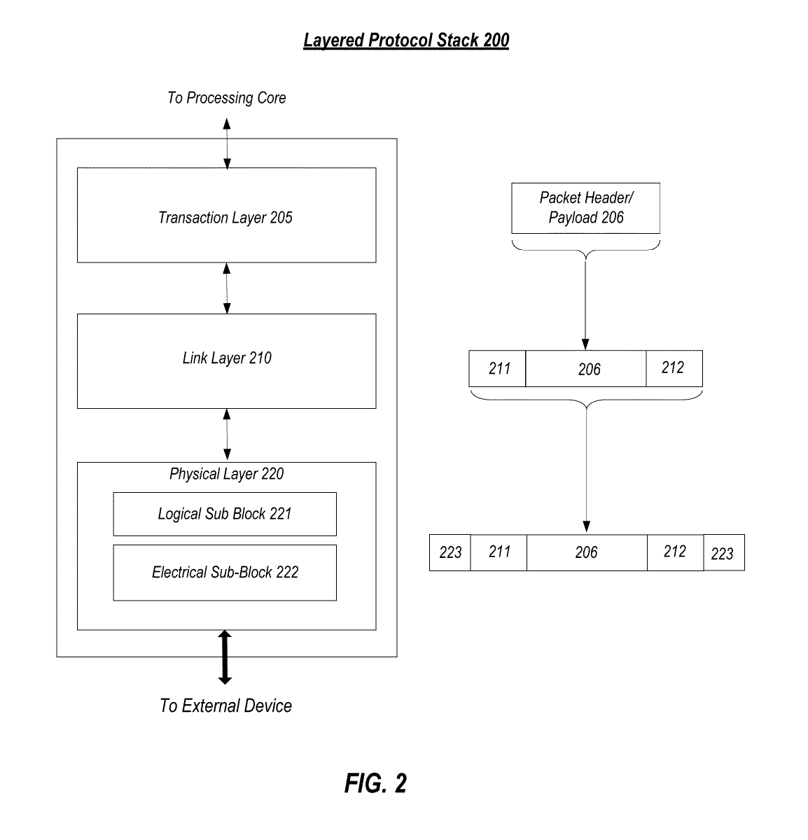

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. Split transactions can also be implemented, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space, for instance, of the PCIe devices. Transactions to the configuration space include read requests and write requests. Message space transactions (or, simply messages) are defined to support in-band communication between agents, such as PCIe agents.

Therefore, in one embodiment, transaction layer 205 assembles packet header/payload 206. Format for current packet headers/payloads of PCIe may be found in the PCIe specification at the PCIe specification website.

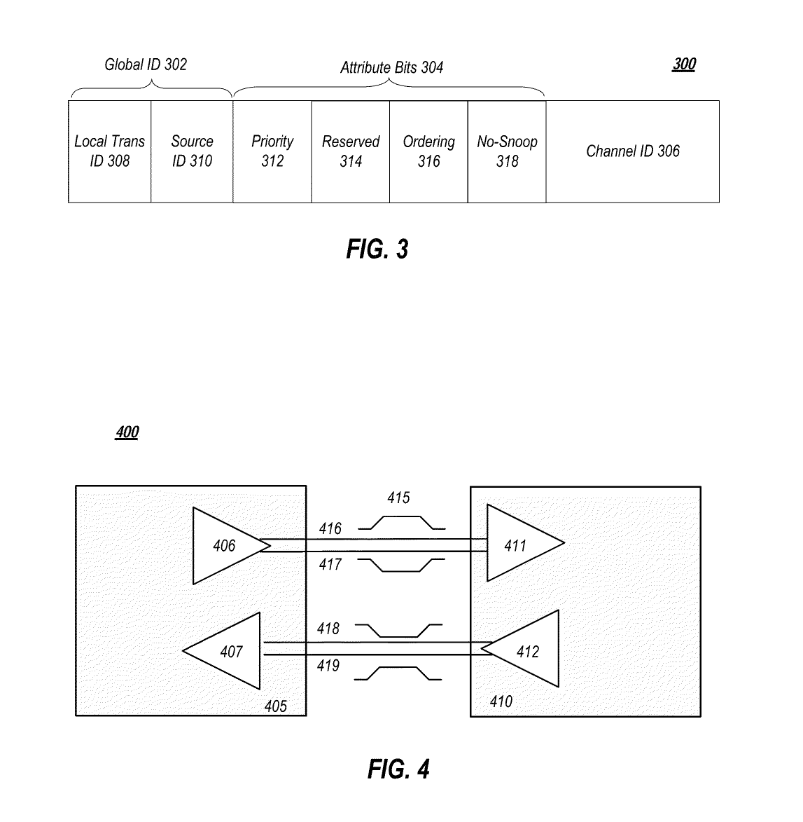

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/411 and a receive pair 412/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

In one embodiment, a new High Performance Interconnect (HPI) is provided. HPI can include a next-generation cache-coherent, link-based interconnect. As one example, HPI may be utilized in high performance computing platforms, such as workstations or servers, including in systems where PCIe or another interconnect protocol is typically used to connect processors, accelerators, I/O devices, and the like. However, HPI is not so limited. Instead, HPI may be utilized in any of the systems or platforms described herein. Furthermore, the individual ideas developed may be applied to other interconnects and platforms, such as PCIe, MIPI, QPI, etc.

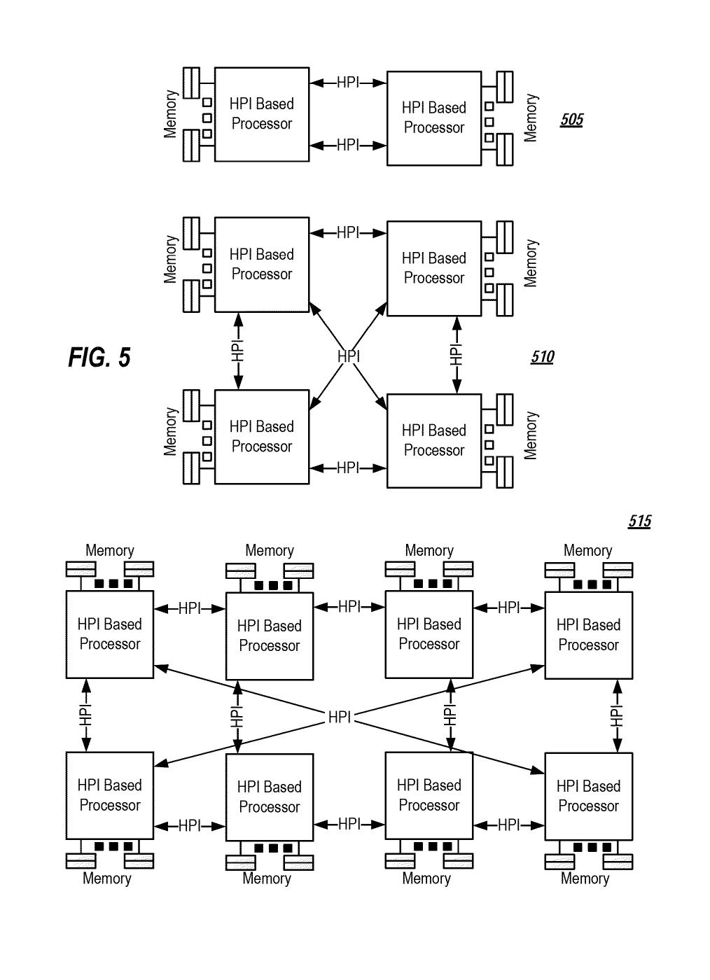

To support multiple devices, in one example implementation, HPI can include an Instruction Set Architecture (ISA) agnostic (i.e. HPI is able to be implemented in multiple different devices). In another scenario, HPI may also be utilized to connect high performance I/O devices, not just processors or accelerators. For example, a high performance PCIe device may be coupled to HPI through an appropriate translation bridge (i.e. HPI to PCIe). Moreover, the HPI links may be utilized by many HPI based devices, such as processors, in various ways (e.g. stars, rings, meshes, etc.). FIG. 5 illustrates example implementations of multiple potential multi-socket configurations. A two-socket configuration 505, as depicted, can include two HPI links; however, in other implementations, one HPI link may be utilized. For larger topologies, any configuration may be utilized as long as an identifier (ID) is assignable and there is some form of virtual path, among other additional or substitute features. As shown, in one example, a four socket configuration 510 has an HPI link from each processor to another. But in the eight socket implementation shown in configuration 515, not every socket is directly connected to each other through an HPI link. However, if a virtual path or channel exists between the processors, the configuration is supported. A range of supported processors includes 2-32 in a native domain. Higher numbers of processors may be reached through use of multiple domains or other interconnects between node controllers, among other examples.

System on chips (“SoCs”) and other devices move through various stages of the device lifecycle from the start when they are born in the fab, through provisioning, test and debug, etc. before transitioning to the final product. Even after entering the market place, devices can be tested and debugged, such as when devices are returned to their manufacturer for debugging. As an SoC moves through these lifecycle stages, various assets are added to the SoC, either by the SoC manufacturer, sub-component vendors, or the customer (e.g., the OEM customer for whom the SoC is made and who will be implementing the SoC in their own products, etc.). Assets can include proprietary data, such as secrets, keys, certificates, and other data to which access is generally restricted. Assets can further include other sensitive digital assets, including executable code provisioned on a component or computing block (or, simply, “block”) within the SoC, among other examples.

A variety of parties can be involved in the development and lifecycle of an SoC device. Assets, including sensitive data and intellectual property, of the respective parties can also be provisioned on the SoC as it progresses through its lifecycle. For instance, assets can be provisioned as computing blocks are added to the SoC, as secret data and proprietary logic and code are added to various computing blocks, among other examples. The owners or providers of these assets may desire, or require, that these assets remain private and/or protected from access by unauthorized users. However, during debugging or testing of the SoC, some of these assets may be at risk of being exposed to the user(s) performing the debugging or testing of the SoC, as the user inspects the various components, data, and operation of the SoC and various computing blocks present and interoperating on the SoC.

Accordingly, it can be desirable in some instances, to further limit access to particular assets and components during debugging or testing of the SoC. For instance, security logic can be provided to define and enforce modes at particular blocks of the SoC, such that assets associated with the particular blocks are protected from access by particular users during debugging or testing. The level of debug access can be based on the identity of the debug user, as some debug users may be authorized to access assets other debug user cannot. Indeed, in some cases, unauthorized access to some assets (e.g., encryption keys, secrets, CPU firmware, power management algorithms, control over execution flow of some logic blocks, etc.) can compromise or threaten the value of the assets. Further, the level of debug access can also vary based on the lifecycle stage of the SoC. For instance, the level of desired debug access (by each respective party) to the SoC can vary as the lifecycle progresses and various assets are provisioned. For example, in the beginning, the SoC may comprise a bare system chassis with no secret or proprietary data or components and unfettered debug access can be provided at least to the verified users associated with the manufacturer of the SoC chassis. However, once secrets, such as content keys are provisioned, access to these assets may be disallowed, even to the engineers manufacturing or debugging the SoC or its subcomponents, and users who once previously enjoyed access to these components during a previous lifecycle stage.

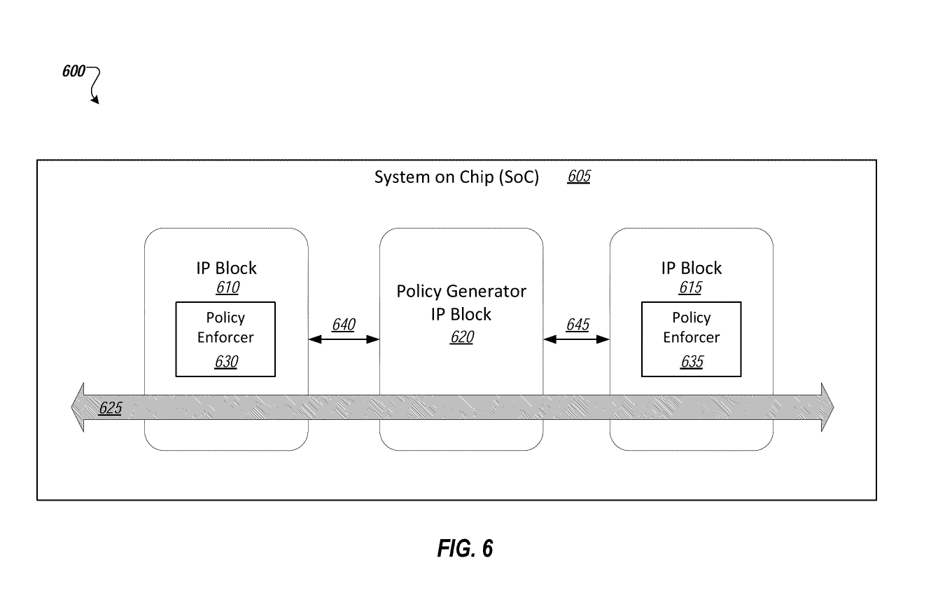

Turning to FIG. 6, a simplified block diagram 600 is shown of a system on chip (SoC) device 605 that includes one or more computing blocks (or “intellectual property (IP) blocks” or “blocks”) 610, 615, 620. The blocks 610, 615, 620 can be interconnected through one or more links and interconnect architecture. For instance, a general purpose or specialized interconnect architecture (e.g., 625) can be used to facilitate communication and memory operations between the computing blocks 610, 615, 620. One or more interconnect protocols, such as PCIe, HPI, QPI, MIPI M-PHY, AMBA, etc. can be employed on the interconnect 615. In some examples, the SoC 605 chassis is provided by a first entity and one or more of the computing blocks (e.g., 610, 615) are provided by one or more other entities (although the same entity can provide both the chassis and all of the component computing blocks in other examples).

In the example of FIG. 6, a central policy generator block 620 is provided to manage debug/testing policies for all (or some other set of) component blocks of the SoC 605. A set of blocks (e.g., 610, 615) can be configured to operate with the policy generator 620 and can include policy enforcer logic (e.g., 630, 635) to enforce block-specific responses to various debug/testing policies. For instance, sideband links (e.g., 640, 645) can be used to facilitate communication between the respective policy enforcer logic 630, 635 and the policy generator 620. In some cases, sideband links 640, 645 can be dedicated sideband links and can insure secure, trusted communication between the policy enforcers 630, 635 and the central policy generator 620.

In some implementations, policy generator block 620 can be configured with hardware and/or software logic to authenticate and determine the identity of a particular debug user, as well as determine the lifecycle stage of the SoC. Various policies can be defined based on the combination of the debug user's identity and the lifecycle of the SoC. The level of debug access to be applied at each respective block (e.g., 610, 615) can be based on the policy and can be block-specific. The respective policy enforcer logic (e.g., 630, 635) can dictate how the corresponding block's debug access is affected by the policy. In some implementations, the policy generator 620 is provided in connection with a defined SoC chassis framework, with each component, or block, configured for the framework. In some examples, compatibility with the framework can dictate the inclusion of policy enforcer logic (e.g., 630, 635) on each component within the SoC 605, such that debug access of every block on the SoC is managed with the assistance of a central policy generator block (e.g., 620) provided in accordance with the defined framework, among other example implementations.

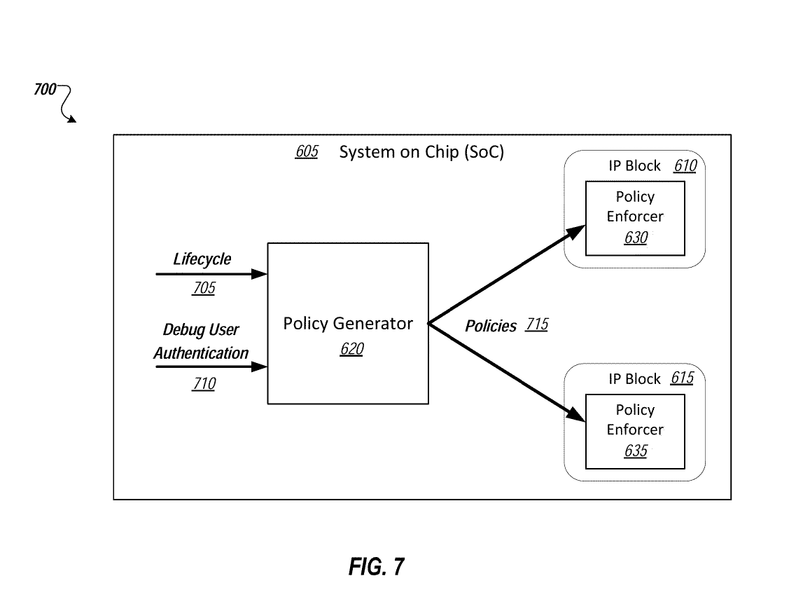

Turning to FIG. 7, a simplified block diagram 700 is provided showing an example of managing debug access within an SoC (e.g., 605). Lifecycle information (or data) 705 can be received or read by the policy generator 620 and a lifecycle stage of the SoC can be determined. Further, debug user authentication information 710 can be received or read by the policy generator 620 to authenticate a user and map the debug user to a particular identity or user classification. Based on the lifecycle information 705 and debug user authentication 710, the policy generator 620 can compute a corresponding debug policy to be applied to the SoC 605. The computed debug policy can then be broadcast 715 (e.g., over secure sideband channels) to all block endpoints (e.g., 610, 615) to alert the respective policy enforcers (e.g., 630, 635) of the policy to be applied during a duration of debug activities by the particular debug user (corresponding to the debug user authentication 710). Each policy enforcer (e.g., 625, 635) can decode the policy signal (e.g., 715) received from the policy generator 620 to identify the policy and determine what activities and/or access to allow at the corresponding block (e.g., 610, 615) during the debug or test session. In some cases, the policy enforcer can define a plurality of access states for its corresponding block, such that various activities at the block are allowed or denied depending on the access state applied at the block. Such activities can include, access to protected assets, access to scan modes within a block (e.g., that allow the user to shift out the data and gain access to the protected asset), among other examples. For instance, the policy enforcer can manage the access state of the block to control access and activity at the block. The policy enforcer can cause the corresponding block to enter a particular one of its defined states based on the policy (e.g., 715) that is broadcast for the SoC 605 during a given debug, test, or use session.

As shown in FIG. 7, in some embodiments, a central policy generator 620 can be provided to apply a common policy 715 across potentially several computing blocks (e.g., 610, 615) of the SoC. Each block can independently manage how that policy is to be applied at the respective block. In these cases, the centralized policy generator does not make complex decision of what debug features each block should expose. Rather, each of the block endpoints (including the IA core) can flexibly make their independent decision (using their respective policy enforcer) of which debug features are to be permitted or denied based on the debug policy 715. Centralizing management of the policy that is to be employed on the SoC, can be beneficial, centralizing authentication of the debug user and determination of the debug policy to apply. Centralizing these aspects can reduce the trusted computing base and allow updates/bug-fixes to be better managed, among other example advantages.

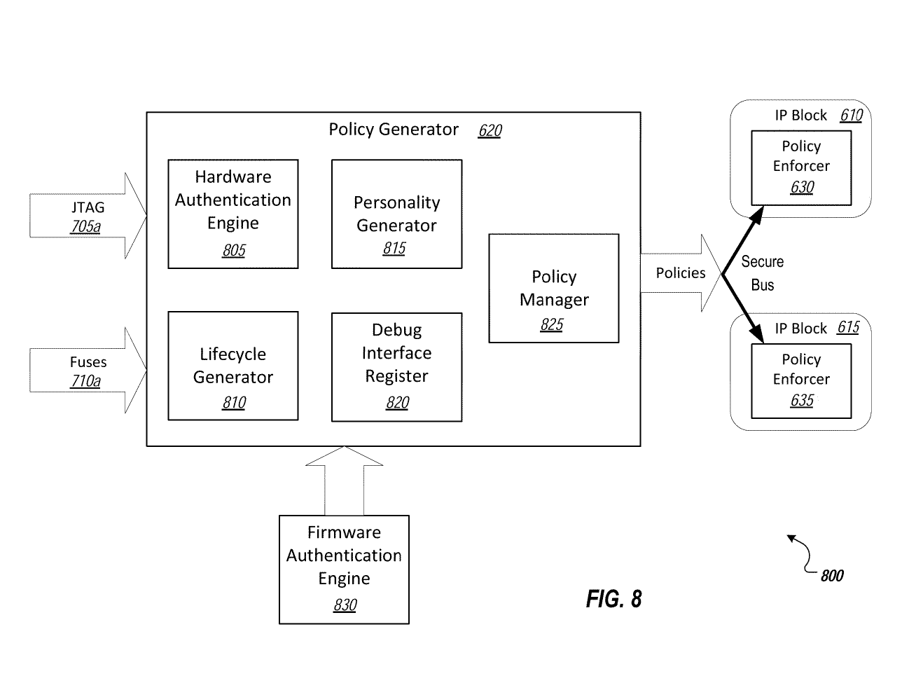

Turning to FIG. 8, a simplified block diagram 800 is shown illustrating a more detailed implementation of the example system described in connection with the block diagram 700 of FIG. 7. In the example of FIG. 8, policy generator 620 can include logical sub-components such as a hardware authentication engine 805, lifecycle generator 810, personality generator 815, debug interface register 820, and policy manager 825, among potentially other sub-components implemented through hardware and/or software. Additional logic can also be provided internal or external to the policy generator 620, including for example, a firmware authentication engine 830.

In this example, a hardware authentication engine 805 can be provided that includes logic to authenticate various debug users or user classes, such as users associated with the manufacturer or provider of the SoC chip substrate, provider of the SoC chassis framework, provider of the SoC interconnect framework, the original equipment manufacturer (OEM) that will include the SoC in a device manufactured by the OEM, providers of software and/or firmware used by one or more blocks of the SoC, providers and vendors of computing blocks to be included on the SoC, among other examples. In this example, hardware authentication engine 805 can receive authentication credential data (e.g., 705a) over a Joint Test Access Group (JTAG) interface. A variety of different credential types can be supported for authentication, such as password identification, manufacturer per-part user identification, and OEM/intermediary per-part user identification, among other examples. Authentication credentials, in some examples, can alternatively, or additionally be provided via firmware or software interfaces. For instance, a firmware authentication engine 830 can be provided at a higher layer in the software stack and be used to authenticate users and communicate the authentication and user information to the policy generator 620. Alternatively, the firmware authentication engine 830 can provide authentication data received through firmware or software to the policy generator 620 for authentication. Whether authenticated through the hardware authentication engine 805 or firmware authentication engine 830, user information can be provided to the personality generator 815 to indicate that the user that has been authenticated. The personality generator 815 can also determine a personality of the user, such as an individual user or category of user authorized to some level of test or debug access on the SoC. Upon setting a personality in a debug session, the personality generator can lock its registers until a new user is authenticated or the debug session is ended. The personality generator registers can be locked to prevent any further modifications on a first-come-first-served basis. The personality output by the personality generator 815 can be provided (e.g., through the personality generator registers or a signal) to the policy manager 825 for consideration in tandem with lifecycle information to determine the policy to apply at the SoC.

Continuing with the example of FIG. 8, a lifecycle generator 810 can be provided that includes logic for determining the development lifecycle state of the SoC. A number of lifecycles can be defined and supported, including Manufacturing, Production, and Decommissioned. As each individual instance of an SoC moves from one stage to the next, the SoC can progress from one lifecycle stage to the next. For example, fuses (e.g., 710a) can be provided on the SoC that can be progressively encoded to denote the current lifecycle state of the individual SoC. For instance, as an SoC progresses from manufacturing the production, additional fuses can be set (e.g., by the party manufacturing or obtaining control of the SoC) to identify that the SoC is no longer in a Manufacturing state, but is now in a Production state, among other examples. Additional fuses can also be provided to allow for additional lifecycle states to be potentially extended and supported. Lifecycle generator 810 can read the fuse data 710a to decode the fuses and identify the present lifecycle state of the SoC. The lifecycle generator 810 can then send a signal or provide an encoding (e.g., such as a two-bit encoding) to identify the lifecycle state to the policy generator 620.

Additional features can also be provided in connection with implementations of a policy generator 620. For instance, a debug interface register (e.g., 820) can be provided to store information that can be used by the policy generator and other SoC subsystems during debugging. For instance, a debug policy or regulation can mandate that permission of a user or device owner, such as a user of a smartphone including a particular SoC, is first obtained before debugging is allowed to be performed on the SoC (e.g., in connection with a service call on the smartphone). This can be provided, for instance, to guard against unauthorized access to the various SoC blocks and memory (and thereby, potentially, the user's personal data). Accordingly, debug interface registers can be used to document that a user's consent has indeed been obtained to allow debug to be performed, and policy generator 620 and/or software used for the debug can read the debug interface register 820 to verify the user's permission as a precondition to allowing certain (or all) debug activities. Debug interface register 820 can include additional information describing a debug session and make this information available to other systems, including operating systems, debug software, etc. implemented in connection with the SoC. For instance, the debug interface register 820 can provide a notification that the SoC is currently under debug or testing (e.g., to alert software to limit its own functions, etc.), identify a debug user, record histories of debug sessions, among other potential information. A debug register 820 can also be used by other blocks on the SoC, including the general or central processing unit, in some examples, such as to populate the architectural privacy machine state registers and other structures. Other SoC IP blocks can also read these registers to read out the user consent and notification information, among other uses.

Policy generator 620 can include logic, such implemented through a policy manager 825, to determine a policy to apply at the SoC based on the combination of lifecycle state and personality, as determined by the personality generator 815 and lifecycle generator 810 respectively. A set of policies can be defined together with a mapping of personality-lifecycle combinations to corresponding debug policies in the set of policies. As a purely illustrative (i.e., non-limiting) example, Table 1 below illustrates one example of such a mapping. For instance, when the SoC is in a manufacturing lifecycle state and a user identified as associated with the SoC manufacturer (e.g., the chipset substrate manufacturer) is authenticated in a debug session, policy manager 825 can identify that a “Security Unlocked” policy is to be applied (e.g., such that the user faces few, if any, debugging restrictions during the session). In another example, the policy generator 620 (using lifecycle generator 810) can identify that the SoC is now in a production lifecycle state and identify (using hardware authentication engine 805 and personality generator 815) that the debug user is an OEM user, to trigger the application of an “OEM Unlocked” policy (e.g., that makes available assets owned by the OEM but locks assets, which the OEM is not permitted to access), among many other potential examples. Indeed, how lifecycle, debug user personality, and debug policies are defined and mapped can be fully customized by the entities involved in the provision of the SoC framework and development of the SoC itself, and can be, in some cases, dictated by co-development agreements formalized between the multiple entities involved in the development of an SoC.

TABLE 1

| Lifecycle State | Personality | Policy Name |
|---|---|---|
| Manufacturing | SoC manufacturer | Security Unlocked |
| Manufacturing | All Others | Security Locked |
| Production | SoC manufacturer | SoC users Unlocked |
| Production | OEM | OEM Unlocked |
| Production | User n | “User n” Unlocked |
| Production | All Others | Security Locked |
| Decommissioned | N/A | Part Disabled |
| Exception | N/A | Functionality Locked |

Upon determining the policy to apply in a debug session based on the lifecycle state and debug user identity (or personality), the policy generator 620 can advertise the policy (e.g., at 715) to all supporting SoC blocks (e.g., 610, 615). For example, a four-bit policy encoding, or other encoding, can be broadcast using secure bus connections between the policy generator block 620 and the other SoC blocks (e.g., 610, 615). The individual policy enforcers (e.g., 630, 635) at each block (e.g., 610, 615) can then independently determine how to enforce the advertised policy at its respective block. For instance, first blocks (e.g., 610) provided by a first entity may enforce a given policy very differently than blocks (e.g., 615) provided by another second entity. As an example, policies that correspond to debugging by a user associated with the first entity could be enforced to allow more comprehensive access to the block (e.g., 610) than at the blocks (e.g., 615) not provided, managed, or owned by the second entity (which may dramatically restrict access based on the user not being a user associated with the second entity), among other examples.

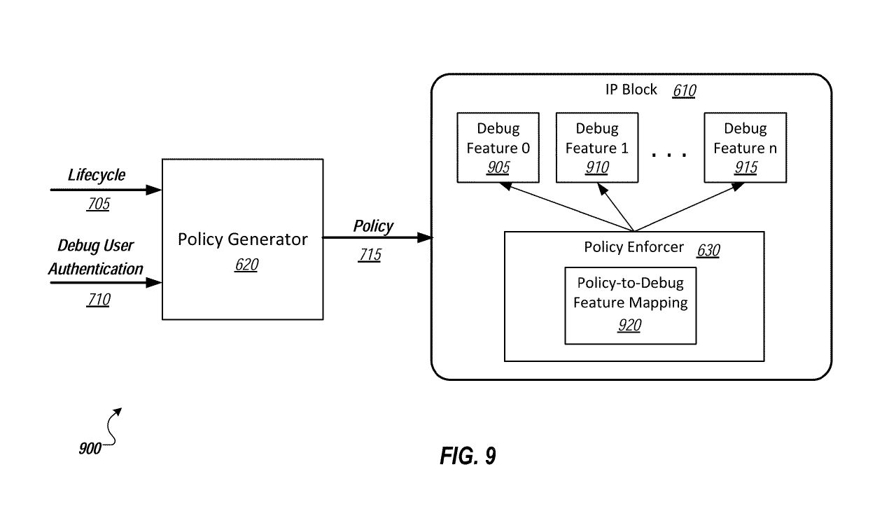

FIG. 9 illustrates a block diagram 900 showing a more detailed view of block-specific policy enforcement. For example, any given computing block may support any number of features or capabilities which might be leveraged or used during a debug session. For instance, such features (or “debug features”) of the block (e.g., 610) can include multiple potential features (e.g., 905, 910, 915) that might be enabled or disabled during the session by the policy enforcer 630 based upon the particular policy determined by the policy generator 620 and applied during the debug session. For instance, when some debug policies are declared for an SoC, one or more of debug features 0-n (e.g., 905, 910, 915) may be disabled, for instance, to protect access to various sensitive assets. In some implementations, policy enforcer 630 can maintain and consult a mapping 920 of defined debug policies (i.e., defined for the SoC) and debug features (e.g., 905, 910, 915). For instance, policy enforcer 630 can receive a policy signal 715 broadcast to blocks (e.g., 610) using a secure bus of the SoC, decode the signal to identify a debug policy to apply during a corresponding debug session, and determine which debug features (e.g., 905, 910, 915) of the block 610 to enable or disable to enforce the particular debug policy based on a consultation of policy-to-debug feature mapping 920.

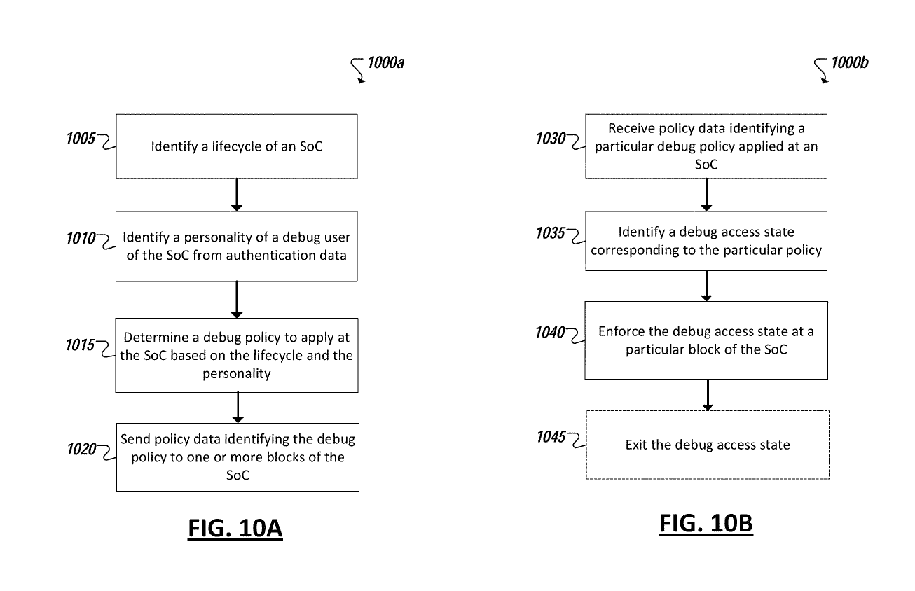

FIGS. 10A-10B are flowcharts 1000a-b illustrating example techniques for managing debug security on a system on chip (SoC). In the example of FIG. 10A, a lifecycle of an SoC is identified 1005, for instance, from data encoded in fuses of the SoC. A personality, or identity, of a debug user is identified 1010 from authentication data. The authentication data can be provided to a dedicated policy generator block on the SoC that is used to manage debug policy for the entire SoC. The user can be authenticated to allow the user to participate in debugging of the SoC based on the authentication data. A debug policy for the debug session of the SoC involving the particular debug user can be determined 1015 based on the identified lifecycle and debug user personality. Debug data can be sent 1020 to one or more (or all) computing blocks on the SoC, where the individual blocks can determine how to enforce the advertised debug policy and protect access to corresponding assets and functions.

Turning to FIG. 10B, policy data can be received by one of a plurality of blocks on an SoC, the policy data advertising a debug policy to be applied at the SoC. A debug access state can be identified that corresponds to the debug policy. The debug access state can identify which debug features of the block should be enabled or blocked during the debug session in accordance with the advertised debug policy. The debug access state can be enforced 1040 at the block during the debug session, for instance, to block access to or disable debug features of the block that are to be restricted during the debug session. In some implementations, additional data can be received or accessed to determine that the debug session has ended and the debug access state can be exited 1045. For instance, a debug state or policy can end through a reset of the SoC, in response to an expiration of time for performing the debug session, in response to a request to begin a new debug session, receipt of new authentication information (e.g., of a different debug user), among other examples.

Note that the apparatus′, methods′, and systems described above may be implemented in any electronic device or system as aforementioned. As specific illustrations, the figures below provide exemplary systems for utilizing the principles described herein. As the systems below are described in more detail, a number of different interconnects are disclosed, described, and revisited from the discussion above. And as is readily apparent, the advances described above may be applied to any of those interconnects, fabrics, or architectures.

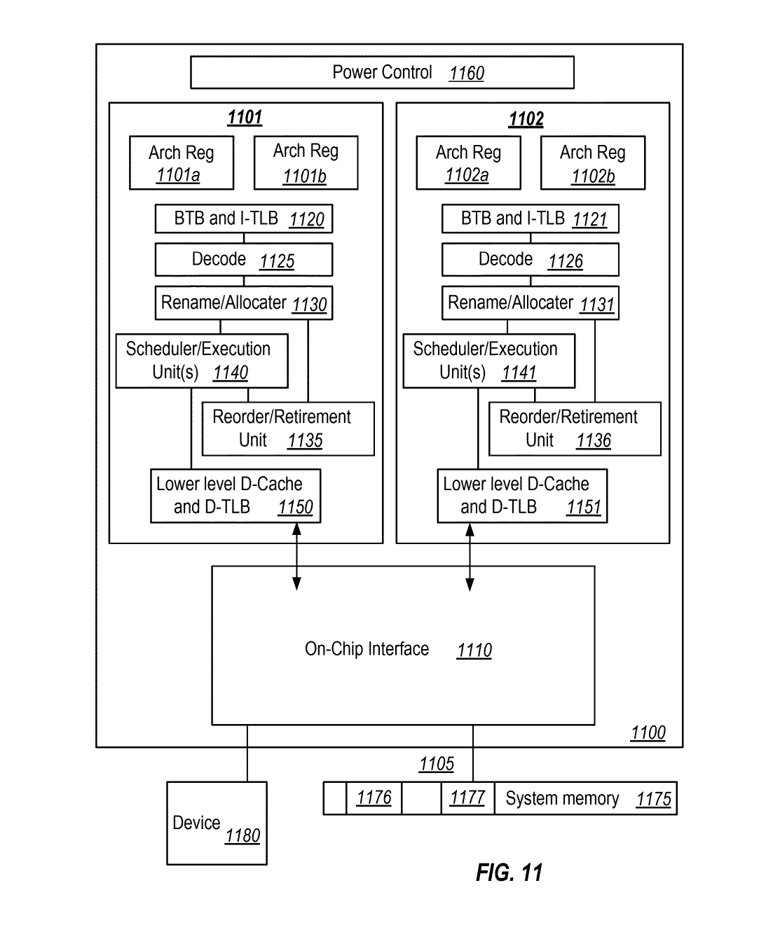

Referring now to FIG. 11, an embodiment of a block diagram for a computing system including a multicore processor is depicted. Processor 1100 includes any processor or processing device, such as a microprocessor, an embedded processor, a digital signal processor (DSP), a network processor, a handheld processor, an application processor, a co-processor, a system on a chip (SOC), or other device to execute code. Processor 1100, in one embodiment, includes at least two cores—core 1101 and 1102, which may include asymmetric cores or symmetric cores (the illustrated embodiment). However, processor 1100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1100, as illustrated in FIG. 11, includes two cores—core 1101 and 1102. Here, core 1101 and 1102 are considered symmetric cores, i.e. cores with the same configurations, functional units, and/or logic. In another embodiment, core 1101 includes an out-of-order processor core, while core 1102 includes an in-order processor core. However, cores 1101 and 1102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1101 are described in further detail below, as the units in core 1102 operate in a similar manner in the depicted embodiment.

As depicted, core 1101 includes two hardware threads 1101a and 1101b, which may also be referred to as hardware thread slots 1101a and 1101b. Therefore, software entities, such as an operating system, in one embodiment potentially view processor 1100 as four separate processors, i.e., four logical processors or processing elements capable of executing four software threads concurrently. As alluded to above, a first thread is associated with architecture state registers 1101a, a second thread is associated with architecture state registers 1101b, a third thread may be associated with architecture state registers 1102a, and a fourth thread may be associated with architecture state registers 1102b. Here, each of the architecture state registers (1101a, 1101b, 1102a, and 1102b) may be referred to as processing elements, thread slots, or thread units, as described above. As illustrated, architecture state registers 1101a are replicated in architecture state registers 1101b, so individual architecture states/contexts are capable of being stored for logical processor 1101a and logical processor 1101b. In core 1101, other smaller resources, such as instruction pointers and renaming logic in allocator and renamer block 1130 may also be replicated for threads 1101a and 1101b. Some resources, such as re-order buffers in reorder/retirement unit 1135, ILTB 1120, load/store buffers, and queues may be shared through partitioning. Other resources, such as general purpose internal registers, page-table base register(s), low-level data-cache and data-TLB 1115, execution unit(s) 1140, and portions of out-of-order unit 1135 are potentially fully shared.

Processor 1100 often includes other resources, which may be fully shared, shared through partitioning, or dedicated by/to processing elements. In FIG. 11, an embodiment of a purely exemplary processor with illustrative logical units/resources of a processor is illustrated. Note that a processor may include, or omit, any of these functional units, as well as include any other known functional units, logic, or firmware not depicted. As illustrated, core 1101 includes a simplified, representative out-of-order (000) processor core. But an in-order processor may be utilized in different embodiments. The 000 core includes a branch target buffer 1120 to predict branches to be executed/taken and an instruction-translation buffer (I-TLB) 1120 to store address translation entries for instructions.

Core 1101 further includes decode module 1125 coupled to fetch unit 1120 to decode fetched elements. Fetch logic, in one embodiment, includes individual sequencers associated with thread slots 1101a, 1101b, respectively. Usually core 1101 is associated with a first ISA, which defines/specifies instructions executable on processor 1100. Often machine code instructions that are part of the first ISA include a portion of the instruction (referred to as an opcode), which references/specifies an instruction or operation to be performed. Decode logic 1125 includes circuitry that recognizes these instructions from their opcodes and passes the decoded instructions on in the pipeline for processing as defined by the first ISA. For example, as discussed in more detail below decoders 1125, in one embodiment, include logic designed or adapted to recognize specific instructions, such as transactional instruction. As a result of the recognition by decoders 1125, the architecture or core 1101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1126, in one embodiment, recognize the same ISA (or a subset thereof). Alternatively, in a heterogeneous core environment, decoders 1126 recognize a second ISA (either a subset of the first ISA or a distinct ISA).

In one example, allocator and renamer block 1130 includes an allocator to reserve resources, such as register files to store instruction processing results. However, threads 1101a and 1101b are potentially capable of out-of-order execution, where allocator and renamer block 1130 also reserves other resources, such as reorder buffers to track instruction results. Unit 1130 may also include a register renamer to rename program/instruction reference registers to other registers internal to processor 1100. Reorder/retirement unit 1135 includes components, such as the reorder buffers mentioned above, load buffers, and store buffers, to support out-of-order execution and later in-order retirement of instructions executed out-of-order.

Scheduler and execution unit(s) block 1140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1150 are coupled to execution unit(s) 1140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1101 and 1102 share access to higher-level or further-out cache, such as a second level cache associated with on-chip interface 1110. Note that higher-level or further-out refers to cache levels increasing or getting further way from the execution unit(s). In one embodiment, higher-level cache is a last-level data cache—last cache in the memory hierarchy on processor 1100—such as a second or third level data cache. However, higher level cache is not so limited, as it may be associated with or include an instruction cache. A trace cache—a type of instruction cache—instead may be coupled after decoder 1125 to store recently decoded traces. Here, an instruction potentially refers to a macro-instruction (i.e. a general instruction recognized by the decoders), which may decode into a number of micro-instructions (micro-operations).

In the depicted configuration, processor 1100 also includes on-chip interface module 1110. Historically, a memory controller, which is described in more detail below, has been included in a computing system external to processor 1100. In this scenario, on-chip interface 1110 is to communicate with devices external to processor 1100, such as system memory 1175, a chipset (often including a memory controller hub to connect to memory 1175 and an I/O controller hub to connect peripheral devices), a memory controller hub, a northbridge, or other integrated circuit. And in this scenario, bus 1105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1175 may be dedicated to processor 1100 or shared with other devices in a system. Common examples of types of memory 1175 include DRAM, SRAM, non-volatile memory (NV memory), and other known storage devices. Note that device 1180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1100. For example in one embodiment, a memory controller hub is on the same package and/or die with processor 1100. Here, a portion of the core (an on-core portion) 1110 includes one or more controller(s) for interfacing with other devices such as memory 1175 or a graphics device 1180. The configuration including an interconnect and controllers for interfacing with such devices is often referred to as an on-core (or un-core configuration). As an example, on-chip interface 1110 includes a ring interconnect for on-chip communication and a high-speed serial point-to-point link 1105 for off-chip communication. Yet, in the SOC environment, even more devices, such as the network interface, co-processors, memory 1175, graphics processor 1180, and any other known computer devices/interface may be integrated on a single die or integrated circuit to provide small form factor with high functionality and low power consumption.

In one embodiment, processor 1100 is capable of executing a compiler, optimization, and/or translator code 1177 to compile, translate, and/or optimize application code 1176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

While the subject matter of the present Specification has been described with respect to a limited number of embodiments, those skilled in the art will appreciate numerous modifications and variations therefrom. It is intended that the appended claims cover all such modifications and variations as fall within the true spirit and scope of this Specification.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present Specification.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform some embodiments may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and a method to identify lifecycle data that identifies a lifecycle of a system-on-chip (SoC), identify authentication data that identifies a particular user to debug the SoC, determine a particular policy based on the lifecycle and identification of the particular user, and send policy data to at least one block of the SoC, the policy data identifying the particular policy. Debug access at the block can be based on the particular policy.

In at least one example, a lifecycle data identifier can identify the lifecycle of the SOC, an authenticator can identify the particular, a policy manager can determine the particular policy based on the lifecycle and identification of the particular user; and a transmitter can send the policy data.

In at least one example, the particular policy is mapped to a combination of the lifecycle and the particular user.

In at least one example, the logic determining the particular policy is implemented on a policy generator block.

In at least one example, the particular policy is determined to be applied for the entire SoC.

In at least one example, the policy data is broadcast to each of a plurality of blocks of the SoC.

In at least one example, the lifecycle data is read from fuses encoded to identify the lifecycle of the SoC.

In at least one example, the authentication data is received via a Joint Test Access Group (JTAG) interface of the SoC.

In at least one example, the authentication data is received from firmware.

In at least one example, the policy manager is further to populate one or more registers with data to describe a debug session corresponding to the debug of the SoC.

In at least one example, the lifecycle includes one of a manufacturing lifecycle state, production lifecycle state, and decommissioned lifecycle state.

In at least one example, the policy data is to be sent over a secure sideband connection.

In at least one example, logic at the block is to determine how to enforce the particular policy at the block.

One or more embodiments may provide an apparatus, a system, a machine readable storage, a machine readable medium, and a method to receive, at a particular block of a system-on-chip (SoC), policy data from a policy generator block of the SoC that identifies a particular one of a plurality of policies, identify a debug access state corresponding to the particular policy, and enforce the debug access state.

In at least one example, the policy generator block determines the particular policy for the entire SoC.

In at least one example, the policy data is broadcast to each of a plurality of blocks on the SoC including the particular block, and each block determines how to enforce the particular policy at the respective block.

In at least one example, a second one of the plurality of blocks uses a different debug access state to enforce the particular policy.

In at least one example, the policy data is to be received over a secure sideband connection between the particular block and the policy generator block.

One or more embodiments may provide a system that includes a system-on-chip (SoC) with a first computing block, a second computing block, and a policy generator block. The policy generator block can identify lifecycle data that identifies a lifecycle of the SOC, identify authentication data that identifies a particular user to debug the SoC, determine a particular policy based on the lifecycle and identification of the particular user, and send policy data to at least the first and second computing blocks, where the policy data identifies the particular policy and debug access at each of the first and second computing blocks is based on the particular policy. The first computing block can include policy enforcement logic to identify a subset of debug features of the first computing block to enable during enforcement of the particular policy to protect access to one or more assets of the first computing block.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the subject matter set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a lifecycle data identifier to identify a lifecycle of a system-on-chip (SoC);
an authenticator to identify a particular user to debug the SoC;
a policy manager to determine a particular policy based on the lifecycle and identification of the particular user; and
a transmitter to send policy data to at least one block of the SoC, wherein the policy data is to identify the particular policy and debug access at the block is based on the particular policy.

2. The apparatus of claim 1, wherein the particular policy is mapped to a combination of the lifecycle and the particular user.

3. The apparatus of claim 1, comprising a policy generator block.

4. The apparatus of claim 1, wherein the policy manager determines the particular policy to be applied for the entire SoC.

5. The apparatus of claim 4, wherein the policy data is broadcast to each of a plurality of blocks of the SoC.

6. The apparatus of claim 1, wherein the lifecycle data is read from fuses encoded to identify the lifecycle of the SoC.

7. The apparatus of claim 1, wherein the authentication data is received via a Joint Test Access Group (JTAG) interface of the SoC.

8. The apparatus of claim 1, wherein the authentication data is received from firmware.

9. The apparatus of claim 1, wherein the policy manager is further to populate one or more registers with data to describe a debug session corresponding to the debug of the SoC.

10. The apparatus of claim 1, wherein the lifecycle comprises one of a group comprising: manufacturing lifecycle state, production lifecycle state, and decommissioned lifecycle state.

11. A method comprising:
identifying lifecycle data, wherein the lifecycle data identifies a lifecycle of a system-on-chip (SoC);
identifying authentication data, wherein the authentication data identifies a particular user to debug the SoC;
determining a particular policy based on the lifecycle and identification of the particular user; and
sending policy data to at least one block of the SoC, wherein the policy data identifies the particular policy and debug access at the block is based on the particular policy.

12. The method of claim 11, wherein the policy data is to be sent over a secure sideband connection.

13. The method of claim 11, wherein logic at the block is to determine how to enforce the particular policy at the block.

14. An apparatus comprising:
policy enforcement logic to:
receive, at a particular block of a system-on-chip (SoC), policy data from a policy generator block of the SoC, wherein the policy data identifies a particular one of a plurality of policies;
identify a debug access state corresponding to the particular policy; and
enforce the debug access state.

15. The apparatus of claim 14, wherein the policy generator block determines the particular policy for the entire SoC.

16. The apparatus of claim 15, wherein the policy data is broadcast to each of a plurality of blocks on the SoC including the particular block, and each block determines how to enforce the particular policy at the respective block.

17. The apparatus of claim 16, wherein a second one of the plurality of blocks uses a different debug access state to enforce the particular policy.

18. The apparatus of claim 14, wherein the policy data is to be received over a secure sideband connection between the particular block and the policy generator block.

19. A system comprising:
a system-on-chip (SoC) comprising:
a first computing block;
a second computing block; and
a policy generator block to:
identify lifecycle data, wherein the lifecycle data identifies a lifecycle of the SoC;
identify authentication data, wherein the authentication data identifies a particular user to debug the SoC;
determine a particular policy based on the lifecycle and identification of the particular user; and
send policy data to at least the first and second computing blocks, wherein the policy data identifies the particular policy and debug access at each of the first and second computing blocks is based on the particular policy.

20. The system of claim 19, wherein the first computing block includes policy enforcement logic to identify a subset of debug features of the first computing block to enable during enforcement of the particular policy to protect access to one or more assets of the first computing block.
